(19) United States
(12) Patent Application Publication
(10) Pub. No.: US 2021/0072804 A1
(43) Pub. Date: Mar. 11, 2021

(54) MOUNTING BRACKET

(71) Applicants: Inventec (Pudong) Technology Corporation, Shanghai (CN); INVENTEC CORPORATION, TAIPEI CITY (TW)

(72) Inventors: Hsiang-Yun LU, TAIPEI CITY (TW); Shiang-Chun TSAU, TAIPEI CITY (TW)

(21) Appl. No.: 16/683,280

(22) Filed: Nov. 14, 2019

(30) Foreign Application Priority Data
Sep. 6, 2019 (CN) 201910844238.5

(51) Int. Cl. G06F 1/18; G11B 33/12

(52) U.S. Cl. CPC G06F 1/187; G11B 33/124

(57) ABSTRACT

A mounting bracket is configured to accommodate a memory card or a hard disk. The mounting bracket includes a base plate, two side plates, a plurality of protruding bumps and at least two supporting structures. The side plates are respectively connected to two opposite edges of the base plate, and extend along a direction perpendicular to the base plate. The protruding bumps are disposed on the base plate and protrude towards the direction. The supporting structures are located between the side plates and respectively disposed on the side plates. When the mounting bracket accommodates the memory card, the protruding bumps are configured to support the memory card. When the mounting bracket accommodates the hard disk, the supporting structures are configured to support the hard disk.

### RELATED APPLICATIONS

This application claims priority to Chinese Application Serial Number 201910844238.5, filed Sep. 6, 2019, which is herein incorporated by reference.

### BACKGROUND

### Technical Field

The present disclosure relates to mounting brackets. More particularly, the present disclosure relates to mounting brackets configured to accommodate a memory card or a hard disk.

### Description of Related Art

With the advancement of technology, in addition to the improvement of performance of general electronic products, the configuration of their physical hardware cannot be ignored.

To be specific, apart from the requirement of lightweight for the hardware, whether the shape of the hardware is space-saving, whether the shape of the hardware has a good look, and even whether the hardware can be easily replaced by the user, etc., have become more important in the eyes of consumers.

### SUMMARY

A technical aspect of the present disclosure is to provide a mounting bracket, which can compatibly accommodate a memory card or a hard disk without using additional component or tool.

According to an embodiment of the present disclosure, a mounting bracket is configured to accommodate a memory card or a hard disk. The mounting bracket includes a base plate, two side plates, a plurality of protruding bumps and at least two supporting structures. The side plates are respectively connected to two opposite edges of the base plate, and extend along a direction perpendicular to the base plate. The protruding bumps are disposed on the base plate and protrude towards the direction. The supporting structures are located between the side plates and respectively disposed on the side plates. When the mounting bracket accommodates the memory card, the protruding bumps are configured to support the memory card. When the mounting bracket accommodates the hard disk, the supporting structures are configured to support the hard disk.

In one or more embodiments of the present disclosure, each of the protruding bumps has a first supporting surface away from the base plate. Each of the first supporting surfaces has a first height relative to the base plate. Each of the supporting structures has a second supporting surface away from the base plate. Each of the second supporting surfaces has a second height relative to the base plate. The second heights are higher than the first heights. When the mounting bracket accommodates the memory card, the first supporting surfaces are configured to support the memory card. When the mounting bracket accommodates the hard disk, the second supporting surfaces are configured to support the hard disk.

In one or more embodiments of the present disclosure, the first heights are the same.

In one or more embodiments of the present disclosure, the second heights are the same.

In one or more embodiments of the present disclosure, the first supporting surfaces are mutually coplanar.

In one or more embodiments of the present disclosure, the second supporting surfaces are mutually coplanar.

In one or more embodiments of the present disclosure, each of the protruding bumps has a locking structure. The locking structure is configured to fix the memory card.

In one or more embodiments of the present disclosure, the protruding bumps are at least partially located between the supporting structures.

In one or more embodiments of the present disclosure, the mounting bracket further includes a pillar. The pillar is configured to connect between one of the protruding bumps and the memory card.

In one or more embodiments of the present disclosure, the mounting bracket further includes at least one locking element. The locking element is disposed at one of the side plates. The locking element is configured to lock the hard disk.

When compared with the prior art, the above-mentioned embodiments of the present disclosure have at least the following advantages:

(1) Since the protruding bumps are at least partially located between the supporting structures, when the mounting bracket accommodates the memory card, the supporting structures do not interfere with the memory card.

(2) Since the second heights of the supporting structures are higher than the first heights of the protruding bumps, when the mounting bracket accommodates the hard disk, the protruding bumps do not interfere with the hard disk.

(3) Since no additional component or tool is required in the procedure to accommodate the memory card or the hard disk in the mounting bracket, it is convenient to the user.

### BRIEF DESCRIPTION OF THE DRAWINGS

The disclosure can be more fully understood by reading the following detailed description of the embodiments, with reference made to the accompanying drawings as follows:

FIG. 1 is a schematic view of a mounting bracket according to an embodiment of the present disclosure;

FIG. 2 is a schematic view of the mounting bracket of FIG. 1, in which the mounting bracket accommodates the memory card;

FIG. 3 is a sectional view along the section line X-X of FIG. 2;

FIG. 4 is a schematic view of the mounting bracket of FIG. 1, in which the mounting bracket accommodates the hard disk; and

FIG. 5 is a front view along the arrow Y of FIG. 4.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

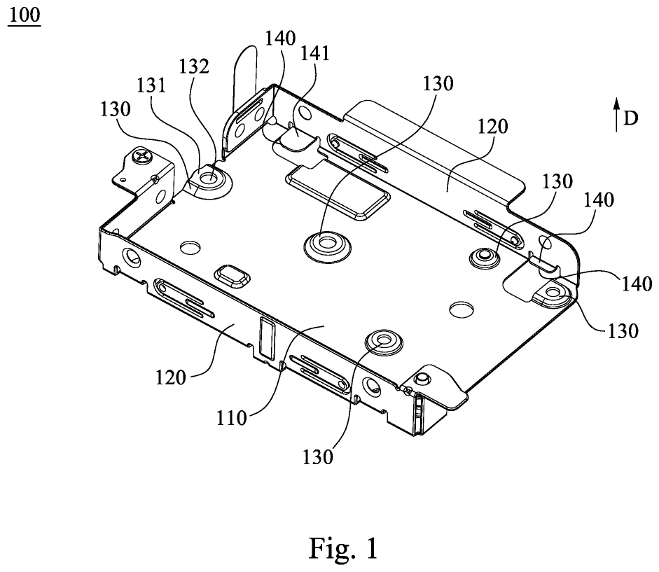

Reference is made to FIG. 1. FIG. 1 is a schematic view of a mounting bracket 100 according to an embodiment of the present disclosure. In some embodiments, as shown in FIG. 1, the mounting bracket 100 includes a base plate 110, two side plates 120, a plurality of protruding bumps 130 and at least two supporting structures 140. The side plates 120 are respectively connected to two opposite edges of the base plate 110. The side plates 120 extend along a direction D perpendicular to the base plate 110. The protruding bumps 130 are disposed on the base plate 110 and protrude towards the direction D. The supporting structures 140 are located between the side plates 120 and respectively disposed on the side plates 120.

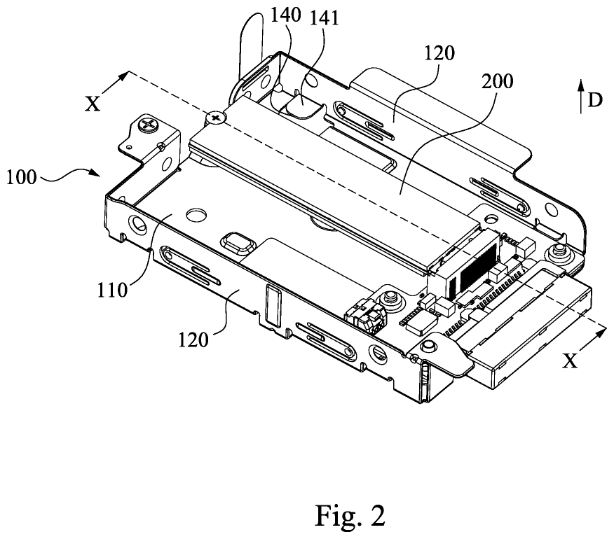

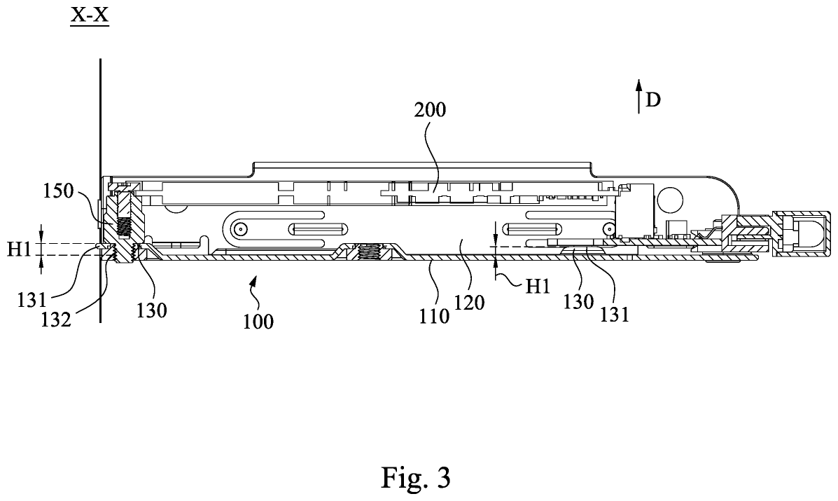

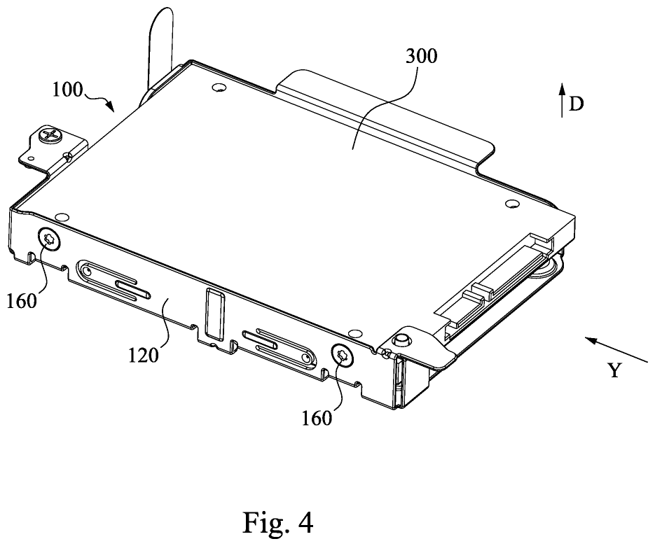

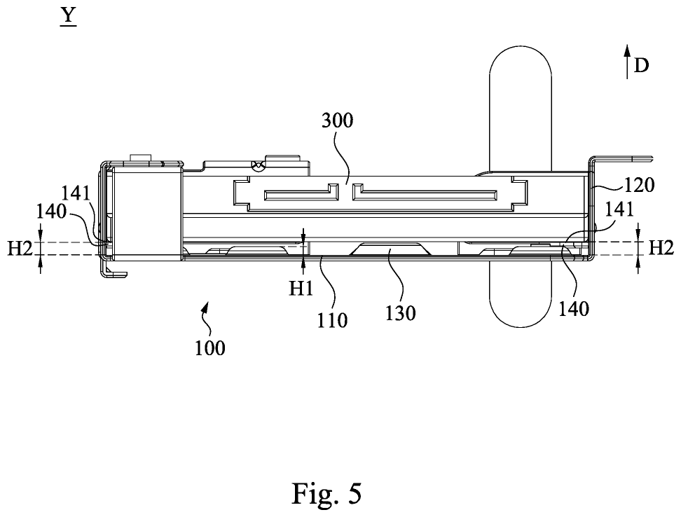

In practical applications, the mounting bracket 100 can compatibly accommodate a memory card 200 (please see FIGS. 2-3) or a hard disk 300 (please see FIGS. 4-5). In practical applications, the memory card 200 can be a M.2 memory card. However, this does not intend to limit the present disclosure. When the mounting bracket 100 accommodates the memory card 200, the protruding bumps 130 are configured to support the memory card 200. Or, when the mounting bracket 100 accommodates the hard disk 300, the supporting structures 140 are configured to support the hard disk 300.

It is worth to note that, as shown in FIG. 1, the protruding bumps 130 are at least partially located between the supporting structures 140. In this way, when the mounting bracket 100 accommodates the memory card 200, the supporting structures 140 do not interfere with the memory card 200.

Please refer to FIG. 2. FIG. 2 is a schematic view of the mounting bracket 100 of FIG. 1, in which the mounting bracket 100 accommodates the memory card 200. To be specific, as shown in FIG. 1, each of the protruding bumps 130 has a first supporting surface 131. The first supporting surface 131 of each of the protruding bumps 130 is away from the base plate 110. When the mounting bracket 100 accommodates the memory card 200, the first supporting surface 131 of each of the protruding bumps 130 is configured to support the memory card 200, such that the mounting bracket 100 accommodates the memory card 200, as shown in FIG. 2.

Please refer to FIG. 3. FIG. 3 is a sectional view along the section line X-X of FIG. 2. In this embodiment, as shown in FIG. 3, the first supporting surface 131 of each of the protruding bumps 130 has a first height H1 relative to the base plate 110. To be specific, the first heights H1 are the same. In other words, the first supporting surfaces 131 of the protruding bumps 130 are mutually coplanar. In this way, the memory card 200 can be securely and horizontally accommodated in the mounting bracket 100.

To be specific, as shown in FIG. 1 and FIG. 3, each of the protruding bumps 130 has a locking structure 132. The locking structure 132 is configured to fix the memory card 200. In practical applications, the locking structure 132 can be a screw hole. However, this does not intend to limit the present disclosure.

In addition, in this embodiment, the mounting bracket 100 further includes a pillar 150. As shown in FIG. 3, the pillar 150 is configured to connect between one of the protruding bumps 130 and the memory card 200. The purpose is that, when the memory card 200 having a shape with a profile of different heights has a gap between one of the protruding bumps 130, the pillar 150 can be connected therebetween, such that the secure and horizontal configuration of the memory card 200 relative to the mounting bracket 100 can be maintained.

Please refer to FIG. 4. FIG. 4 is a schematic view of the mounting bracket 100 of FIG. 1, in which the mounting bracket 100 accommodates the hard disk 300. To be specific, as shown in FIG. 1, each of the supporting structures 140 has a second supporting surface 141. The second supporting surface 141 of each of the supporting structures 140 is away from the base plate 110. When the mounting bracket 100 accommodates the hard disk 300, the second supporting surface 141 of each of the supporting structures 140 is configured to support the hard disk 300, such that the mounting bracket 100 accommodates the hard disk 300, as shown in FIG. 4.

In addition, the mounting bracket 100 further includes at least one locking element 160. As shown in FIG. 4, when the mounting bracket 100 accommodates the hard disk 300, the locking element 160 is disposed at one of the side plates 120, and is configured to lock the hard disk 300, in order to fix the relative position between the hard disk 300 and the mounting bracket 100. In practical applications, the locking element 160 can be a screw. However, this does not intend to limit the present disclosure.

Please refer to FIG. 5. FIG. 5 is a front view along the arrow Y of FIG. 4. In this embodiment, as shown in FIG. 5, the second supporting surface 141 of each of the supporting structure 140 has a second height H2 relative to the base plate 110. To be specific, the second heights H2 are the same. In other words, the second supporting surfaces 141 of the supporting structures 140 are mutually coplanar. In this way, the hard disk 300 can be securely and horizontally accommodated in the mounting bracket 100.

It is worth to note that, the second heights H2 of the supporting structures 140 are higher than the first heights H1 of the protruding bumps 130. In this way, when the mounting bracket 100 accommodates the hard disk 300, the protruding bumps 130 do not interfere with the hard disk 300.

In practical applications, as mentioned above, since no additional component or tool is required in the procedure to accommodate the memory card 200 or the hard disk 300 in the mounting bracket 100, it is convenient to the user.

In conclusion, when compared with the prior art, the aforementioned embodiments of the present disclosure have at least the following advantages.

(1) Since the protruding bumps are at least partially located between the supporting structures, when the mounting bracket accommodates the memory card, the supporting structures do not interfere with the memory card.

(2) Since the second heights of the supporting structures are higher than the first heights of the protruding bumps, when the mounting bracket accommodates the hard disk, the protruding bumps do not interfere with the hard disk.

(3) Since no additional component or tool is required in the procedure to accommodate the memory card or the hard disk in the mounting bracket, it is convenient to the user.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A mounting bracket, configured to accommodate a memory card or a hard disk, the mounting bracket comprising:
a base plate;
two side plates respectively connected to two opposite edges of the base plate, and extending along a direction perpendicular to the base plate;
a plurality of protruding bumps disposed on the base plate and protruding towards the direction; and
at least two supporting structures located between the side plates and respectively disposed on the side plates,
wherein when the mounting bracket accommodates the memory card, the protruding bumps are configured to support the memory card, when the mounting bracket accommodates the hard disk, the supporting structures are configured to support the hard disk.

2. The mounting bracket of claim 1, wherein each of the protruding bumps has a first supporting surface away from the base plate, each of the first supporting surfaces has a first height relative to the base plate, each of the supporting structures has a second supporting surface away from the base plate, each of the second supporting surfaces has a second height relative to the base plate, the second heights are higher than the first heights,
wherein when the mounting bracket accommodates the memory card, the first supporting surfaces are configured to support the memory card, when the mounting bracket accommodates the hard disk, the second supporting surfaces are configured to support the hard disk.

3. The mounting bracket of claim 2, wherein the first heights are the same.

4. The mounting bracket of claim 2, wherein the second heights are the same.

5. The mounting bracket of claim 2, wherein the first supporting surfaces are mutually coplanar.

6. The mounting bracket of claim 2, wherein the second supporting surfaces are mutually coplanar.

7. The mounting bracket of claim 1, wherein each of the protruding bumps has a locking structure configured to fix the memory card.

8. The mounting bracket of claim 1, wherein the protruding bumps are at least partially located between the supporting structures.

9. The mounting bracket of claim 1, further comprising:
a pillar configured to connect between one of the protruding bumps and the memory card.

10. The mounting bracket of claim 1, further comprising:
at least one locking element disposed at one of the side plates and configured to lock the hard disk.
